(19) United States
(12) Patent Application Publication
(10) Pub. No.: US 2005/0246040 A1
(43) Pub. Date: Nov. 3, 2005

(54) Operator profile control system for a work machine

(75) Inventors: Robert Ahern Horkavi, Dunlap, IL (US); Gary Lee Spadin, Chillicothe, IL (US); Steven Wayne O'Neal, Bartonville, IL (US); Michael David Staub, Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 10/834,278

(22) Filed: Apr. 29, 2004

(51) Int. Cl. G05B 15/00

(52) U.S. Cl. 700/83

(57) ABSTRACT

A control system for a work machine has an input device operable to receive an input indicative of an operator profile and to generate a signal related to the operator profile. The control system also has a controller in communication with the work machine and the input device. The controller is configured to receive the signal and to change at least one operating parameter of the work machine in response to the signal.

### TECHNICAL FIELD

The present disclosure relates generally to a control system for a work machine, and more particularly, to a control system for a work machine that is linked to an operator profile.

### BACKGROUND

Work machines such as, for example, wheel loaders, track type tractors, articulated trucks, excavators, and other types of machinery are used for a variety of tasks. These work machines may be capable of producing substantial amounts of speed and torque with ground-engaging traction devices and/or with various work implements. Operation of these work machines may be complex and may require highly skilled operators to utilize the work machine's full capabilities. However, there may be instances when the full capabilities of the work machine are not required and/or not desired.

When the full capabilities of the work machine are not required, operation of the work machine by a highly skilled operator may be inefficient.

For example, regular maintenance of a work machine may only require operation of a work machine's power source, without any required movement of work implements or the work machine. In addition, transportation of the work machine to or from a work site may not require the full capabilities of the work machine. During these situations, an operator with a lower skill level may efficiently operate the work machine.

In addition, it may be desirous to limit the full capabilities of the work machine in order to protect the work machine against misuse or abuse by an operator with a lower skill level, and/or for safety reasons. For example, a maintenance technician, trainee, or lessee of rental equipment may not have the skills to safely operate the work machine when the work machine's full capabilities are available. In these circumstances, it may be desirous to limit the available work machine capabilities to a lower output level controllable by an operator having a lower skill level.

One effort to selectively control work machine operation is described in U.S. Pat. No. 6,522,251 (the '251 patent) issued to Menne et al. on Feb. 18, 2003. The '251 patent describes a machine security system interacting with a starter to start an engine of a work machine in response to an identification code. The identification code may be given to an operator who has rented the machine, thereby giving the operator access to the machine for a period of time or during a particular time of day. Different identification codes may be given to different operators, allowing them different access times or time periods.

Although the machine security system of the '251 patent may restrict a particular operator from using a work machine during a particular period of time or during a particular time of day, the machine security system does not change the output of the work machine in response to the operator's profile. An unskilled operator may still have access to the full capabilities of the work machine during his/her accessible time.

The disclosed system is directed to overcoming one or more of the problems set forth above.

### SUMMARY OF THE INVENTION

In one aspect, the present disclosure is directed to a control system for a work machine. The control system includes an input device operable to receive an input indicative of an operator profile and to generate a signal relating to the operator profile. The control system also includes a controller in communication with the work machine and the input device. The controller is configured to receive the signal and to change at least one operating parameter of the work machine in response to the signal.

In another aspect, the present disclosure is directed to a method of operating a work machine. The method includes receiving a code indicative of an operator profile with an input device and generating a signal in response to the code. The method further includes changing at least one operating parameter of the work machine in response to the signal such that the at least one operating parameter falls within a predetermined range related to the operator profile.

In yet another aspect, the present disclosure is directed to a method of limiting work machine functionality. The method includes creating an operator profile and generating a code corresponding to the operator profile, wherein the code is configured for entry into an input device of the work machine.

### BRIEF DESCRIPTION OF THE DRAWINGS

FIG. 1 is a schematic illustration of a control system according to an exemplary disclosed embodiment.

### DETAILED DESCRIPTION

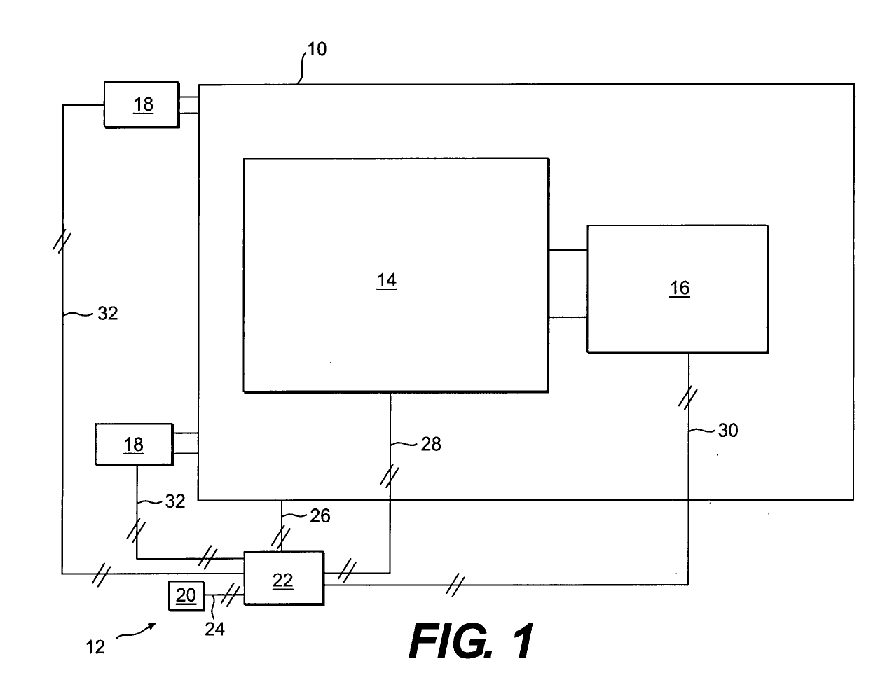

FIG. 1 illustrates a work machine 10 having an exemplary embodiment of a control system 12 disposed on work machine 10. Work machine 10 may be a fixed or mobile machine that performs some type of operation associated with an industry such as mining, construction, farming, or any other industry known in the art. For example, work machine 10 may be an earth moving machine, a generator set, a pump, a marine vessel, an aircraft, or any other suitable operation-performing work machine. Work machine 10 may include a power source 14 operatively connected to a transmission 16 and may also include a plurality of work implements 18.

Power source 14 may be configured to produce a power output at a range of output speeds and torques. Power source 14 may be an engine such as, for example, a diesel engine, a gasoline engine, a natural gas engine, or any other suitable engine. Power source 14 may also be another source of power such as, for example, a fuel cell, a power storage device, or any other source of power known in the art.

Transmission 16 may be configured to transmit power from power source 14 to an output device (not shown) at a range of output speed ratios. Transmission 16 may be a hydraulic transmission, a mechanical transmission, a hydro-mechanical transmission, an electric transmission, or any other suitable transmission. The output device may include such devices as a ground engaging device, a pump, a generator, a propeller, or any other output device known in the art. It is also contemplated that transmission 16 may transmit power from power source 14 to the output device at only one output speed ratio.

Work implements 18 may be operatively connected to work machine 10 in any manner such as, for example, via a hydraulic circuit (not shown), via an electronic circuit (not shown), directly to power source 14 or transmission 16, or in any other suitable manner. Work implements 18 may include such devices as a bucket, a shovel, a blade, a ripper, a claw, a power take off device, or any other suitable device. Work implements 18 may be manually controlled by an operator to perform a desired function, or, alternately, may be automatically operated by work machine 10.

Control system 12 may be in communication with work machine 10, power source 14, transmission 16, and work implements 18. Control system 12 may include an input device 20 and a controller 22.

Input device 20 may include a means for receiving a code and generating a signal indicative of the code such as, for example, a keypad allowing the code to be manually entered by an operator, a switch configured to receive a coded key having magnetic information on the key or a memory chip, a data port allowing direct communication with a service tool or a computer having the code, an antenna allowing reception of the code from a remote location, a bio-metric device configured to recognizing an operator based on a physiological or behavioral characteristic, or any other configuration that can receive the code and generate a signal in response to the code. A code, for the purposes of the present disclosure, may include a configuration of letters, numbers, symbols, pulses, voltage levels, bar codes, signals, magnetic fields, sound or light waves, and other configurations that represent an assigned meaning. The code may take the form of one or more of human readable information and machine readable information. Input device 20 may be in communication with controller 22 via communication line 24.

Controller 22 may be configured to receive the signal generated by input device 20 and to change an operating parameter in response to the signal. Controller 22 may be in communication with work machine 10, power source 14, transmission 16, and work implements 18, via communication lines 26, 28, 30, and 32, respectively. Controller 22 may include any means for controlling an operating parameter of work machine 10 such as, for example, a memory, one or more data storage devices, a central processing unit, or any other components that may be used to run an application. Furthermore, although aspects of the present disclosure may be described as being stored in memory, one skilled in the art will appreciate that these aspects can be stored on or read from other types of computer program products or computer-readable media, such as computer chips and secondary storage devices, including hard disks, floppy disks, optical media, CD-ROM, or other forms of RAM or ROM. Controller 22 may also include components such as, for example, mechanical or hydro-mechanical devices. Various other known circuits may be associated with controller 22 such as, for example, power supply circuitry, signal-conditioning circuitry, solenoid driver circuitry, communication circuitry, and other appropriate circuitry.

### INDUSTRIAL APPLICABILITY

The disclosed control system may be applicable to any work machine where it is advantageous to control parameters of the work machine based on an operator profile. Controlling parameters of the work machine based on operator profile may add a level of protection for the work machine and/or safety for the operator by limiting operation of equipment that may require a different skill level than what is possessed by the operator. Controlling parameters of the work machine based on operator profile may also allow for increased customization of services offered to a lessee of rental equipment by only allowing and only charging for access to specific work machine capabilities desired by the lessee.

As explained above, different work machine operators may have different levels of skill in operating work machine. For example, a lessee of rental equipment or a trainee may have little or no experience or skill operating a work machine. A service technician may have some experience operating the work machine. This experience, however, may be limited to operation of only portions of the work machine, such as a power source or a work implement of the work machine. Similarly, a transportation technician may skillfully drive a work machine at low speeds, in a particular direction, and/or for short distances during loading and unloading of the work machine. It is unlikely that the lessee, the service technician, or the transportation technician individually possesses sufficient skill to operate all of the functions of the work machine. In contrast, however, an operator with the responsibility of continuously operating all functions of the work machine on a regular basis may have a very high skill level.

Controlling parameters of a work machine based on operator profile may include limiting operation of a work machine within work machine limits, power source output limits, transmission output limits, work implement limits, time of day or time duration limits, or other appropriate limits that correspond with the operator's experience, skill level, and/or other profile-based factor. For example, the lessee may be limited in all areas of work machine usage because of a low level of experience and/or skill. Likewise, the service technician may be limited to operating only the power source or the work implement for which the technician has been trained to service. Similarly, the transportation technician may be blocked from operating any work implements and may be limited to minimal travel speed and specified directions. In contrast, however, certain skilled operators may be granted full access to all machine functions.

As an additional possibility, a lessee only desiring to use a particular work implement, function, and/or feature of the work machine may be assigned an operator profile that limits or blocks access to controls of other work implements, functions, and features of the work machine. In this manner, the work implements, functions, and features not accessible to the customer may sustain less wear and require less maintenance. The lower levels of wear and maintenance may allow rental equipment to be rented for a lower cost, thereby providing increased customization for the lessee.

An operator profile and associated work machine accessibility may be created by a manager of a construction company, a foreman of a construction site, a rental store employee, a manufacturer of the work machine or any other entity with suitable authority. The operator profile may be based on attributes relating to an operator's experience level, an operator's skill level, an operator's physical ability level, a purchased access level, or any other suitable indicators on which an access level determination to functions of work machine 10 may be based.

Controller 22 may include lists, lookup tables, or other data structures for storing access rights and limitation configurations on a memory of controller 12 that correspond to predetermined profiles. Controller 22 may be configured to change operating parameters of work machine 10 such that the operating parameters fall within predetermined ranges related to the predetermined profiles. These profiles may be determined according to different types of operator groups. It is also contemplated that each operator may be assigned a unique profile corresponding to a particular arrangement of access rights and limitation configurations specific to the particular operator.

After establishing a profile for an operator that is representative of an experience level, skill level, physical ability level, and/or purchased access level of the operator, a code may be generated corresponding to the profile. This code may be entered into input device 20 in a variety of ways, depending on the configuration of input device 20. For example, input device 20 may include a keypad, the code being given to an operator in the form of letters, numbers, or a combination of both to be manually entered into control system 12. Alternately, input device 20 may include a switch such as an ignition switch or a dedicated switch, the code being delivered to control system 12 by means of a magnetic strip or a memory chip encoded and imbedded in a key given to an operator. Input device may also include a scanner configured to read a barcode or other suitable encoded indicia. Input device may also include a bio-metric device for recognizing an operator based on a physiological or behavioral characteristic. Input device 20 may also deliver the code to control system 12 via a data port, an antenna, or any other means known in the art. The particular code entered into input device 20 may be transferred through control system 12 of work machine 10 as a signal received by controller 22. Controller 22 may then grant or deny access to particular work implements, functions and/or features of work machine 10 depending on the profile established for the particular operator.

Controller 22 may be in communication with various components of work machine 10, power source 14, and transmission 16 such as, for example, speed sensors, load sensors, travel direction sensors, implement range sensors, implement force sensors, implement and transmission pressure sensors, fuel maps air induction maps, timing maps, fuel injectors, hydraulic pumps, motors, actuators, and other appropriate components. Controller 22 may be configured to change appropriate operating parameters of these components in response to the signal from input device 20 indicative of an operator profile and the signals from various sensors that enable controller 22 to assess the operating parameters of work machine 10. Using this information, controller 22 may limit work implement motion and/or work machine output, power source output, and/or transmission output.

Work machine output limits may include, among other things, a maximum travel speed, a maximum travel acceleration, a maximum rimpull torque, a maximum payload, a travel direction, or other work machine output limits known in the art. Maximum travel speed, acceleration, and rimpull torque may be limited by, for example, controlling an associated maximum throttle setting, an injection timing, an air induction characteristic, a hydraulic pressure in a transmission of the work machine, a speed command to transmission 16 of work machine 10, or other suitable parameters. Maximum payload may be limited by limiting a hydraulic pressure in a work implement, by restricting movement of work machine 10 when loaded above a predetermined load limit, or by controlling other parameters known in the art. Travel direction may be limited by reducing maneuverability of a steering mechanism or by reducing selectability of transmission rotational directions.

Power source output limits may include, for example, a maximum power source speed, a maximum power source torque, a maximum power source acceleration, a maximum current and/or voltage output, or other appropriate power source limitations. These limits may be controlled by limiting an associated maximum fuel setting, an injection timing, an air induction characteristic, a number of firing cylinders, or in other ways known in the art.

Transmission output limits may include, among other things, a maximum output speed of transmission 16 of work machine 10 or other transmission limitations known in the art. The output speed of transmission 16 may be limited by controlling a maximum speed command, a current or hydraulic pressure directed to a motor, a maximum pump or motor displacement, a maximum selectable speed ratio, or in other ways known in the art.

Work implement limits may include, for example, acceleration limits, speed limits, force limits, range of motion limits, or limits to particular work implements 18. The acceleration, speed, and force limits may be established by controlling a maximum hydraulic pressure to an actuator, a maximum pump flow rate, a maximum implement displacement distance, a maximum voltage to an actuator, a maximum control mechanism motion, or in other suitable ways. Access to particular work implements 18 may be limited by preventing a current or pressure from being supplied to work implements 18.

It will be apparent to those skilled in the art that various modifications and variations can be made to the disclosed control system without departing from the scope of the invention. Other embodiments will be apparent to those skilled in the art from consideration of the specification. For example, in the situation when the operator profile indicates the operator having a low skill level, the corresponding code supplied to the operator may be configured to invoke a training program, which may or may not require completion by the operator before expanding work machine and/or work implement functions, features, and/or accessibility. It is intended that the specification and examples be considered as exemplary only, with a true scope of the invention being indicated by the following claims and their equivalents.

1. A control system for a work machine, comprising:
an input device operable to receive an input indicative of an operator profile and to generate a signal related to the operator profile;
a controller in communication with the work machine and the input device, the controller configured to receive the signal and to change at least one operating parameter of the work machine in response to the signal.

2. The control system of claim 1, wherein the input device includes a keypad.

3. The control system of claim 1, wherein the input device includes a switch configured to receive an encoded key.

4. The control system of claim 1, wherein the input device includes an antenna configured to receive a remotely transmitted code.

5. The control system of claim 1, wherein the input device includes a data port configured to receive a directly transmitted code.

6. The control system of claim 1, wherein the input device includes a scanner configured to read an encoded indicia.

7. The control system of claim 1, wherein the input device is a biometric device.

8. The control system of claim 1, wherein the operator profile is related to at least one of a skill level, an experience level, and a physical ability of the operator.

9. The control system of claim 1, wherein the operator profile is related to a purchased access level.

10. The control system of claim 1, wherein the at least one operating parameter includes at least one of a work machine travel speed limit, a work machine travel acceleration limit, a work machine torque level limit, and a work machine travel direction limit.

11. The control system of claim 1, wherein the work machine includes a power source, the controller being in communication with the power source, and the at least one operating parameter includes a power source output limit.

12. The control system of claim 1, wherein the work machine includes a transmission, the controller being in communication with the transmission, and the at least one operating parameter includes a transmission output limit.

13. The control system of claim 1, wherein the work machine includes at least one work implement, the controller being in communication with the at least one work implement, and the at least one operating parameter includes a work implement limit.

14. The control system of claim 13, wherein the work implement limit is related to accessibility of the at least one work implement.

15. The control system of claim 1, wherein the controller includes a memory having at least one predetermined profile stored therein, and the controller is configured to change the at least one operating parameter when the operator profile matches the at least one predetermined profile.

16. A method of operating a work machine, comprising
receiving a code indicative of an operator profile with an input device;
generating a signal in response to the code; and
changing at least one operating parameter of the work machine in response to the signal such that the at least one operating parameter falls within a predetermined range related to the operator profile.

17. The method of claim 16, wherein the operator profile is related to at least one of a skill level, an experience level, and a physical ability of the operator.

18. The method of claim 16, wherein the operator profile is related to a purchased access level.

19. The method of claim 16, wherein the work machine includes a power source and changing at least one operating parameter of the work machine includes changing a power source output limit.

20. The method of claim 16, wherein the work machine includes a transmission and changing at least one operating parameter of the work machine includes changing a transmission output limit.

21. The method of claim 16, wherein the work machine includes at least one work implement and changing at least one operating parameter of the work machine includes changing a work implement limit.

22. The method of claim 16, further including changing the at least one operating parameter to a predetermined setting when the signal corresponds to a predetermined profile.

23. A method for limiting work machine functionality, comprising:
assessing a potential operator of the work machine;
creating an operator profile for the potential operator; and
generating a code corresponding to the operator profile, wherein the code is configured for entry into an input device of the work machine.

24. The method of claim 23, further including changing at least one operating parameter of the work machine in response to the code being entered into an input device of the work machine such that the at least one operating parameter falls within a predetermined range related to the operator profile.

25. The method of claim 23, wherein the operator profile is related to at least one of a skill level, an experience level, and a physical ability of the operator.

26. The method of claim 23, wherein the operator profile is related to a purchased access level.

27. The method of claim 24, wherein the work machine includes a power source and the at least one operating parameter of the work machine includes a power source output limit.

28. The method of claim 24, wherein the work machine includes a transmission and the at least one operating parameter of the work machine includes a transmission output limit.

29. The method of claim 24, wherein the work machine includes at least one work implement and the at least one operating parameter of the work machine includes a work implement limit.

30. The method of claim 24, wherein the at least one operating parameter is changed to a predetermined setting when the signal corresponds to a predetermined profile.

31. A work machine, comprising:
a power source;
a transmission operatively connected to the power source;
an input device operable to receive an input indicative of an operator profile and to generate a signal related to the operator profile;
a controller in communication with the work machine and the input device, the controller configured to receive the signal and to change at least one operating parameter of the work machine in response to the signal.

32. The work machine of claim 31, wherein the operator profile is related to at least one of a skill level, an experience level, and a physical ability of the operator.

33. The work machine of claim 31, wherein the operator profile is related to a purchased access level.

34. The work machine of claim 31, wherein the controller is in communication with the power source, and the at least one operating parameter includes a power source output limit.

35. The work machine of claim 31, wherein the controller is in communication with the transmission, and the at least one operating parameter includes a transmission output limit.

36. The work machine of claim 31, wherein the work machine includes at least one work implement, the controller being in communication with the at least one work implement, and the at least one operating parameter includes a work implement limit.

37. A control system for a work machine, comprising:
a means for receiving an input indicative of an operator profile and for generating a signal corresponding to the operator profile;
a means for controlling at least one operating parameter of the work machine in response to the signal.

38. The control system of claim 37, wherein the operator profile is related to at least one of a skill level, an experience level, and a physical ability of the operator.

39. The control system of claim 37, wherein the operator profile is related to a purchased access level.
